(19) United States
(12) Patent Application Publication
(10) Pub. No.: US 2005/0145196 A1
(43) Pub. Date: Jul. 7, 2005

(54) Barking episode counter and method for bark control device

(76) Inventors: Timothy J. Crist, Tucson, AZ (US); Francisco J. Napolez, Tucson, AZ (US); Alice A. Woodyard, Sacramento, CA (US)

Correspondence Address: Cahill, von Hellens & Glazer P.L.C., 2141 East Highland Avenue, 155 Park One, Phoenix, AZ, 85016, US

(21) Appl. No.: 10/752,795

(22) Filed: Jan. 7, 2004

(51) Int. Cl. A01K 15/02; A01K 27/00

(52) U.S. Cl. 119/718

(57) ABSTRACT

A collar-mounted electronic apparatus (1) for control of barking by a dog includes a housing (2) supported by a collar for attachment to the dog's neck, first and second stimulus probes (5) connected to a surface (9) of the housing, a vibration sensor (6) supported by the housing for detecting vibrations caused by barking by the dog and control circuitry in the housing having an input coupled to an output of the vibration sensor. The control circuitry includes output terminals producing aversive stimulus signals in response to barking by the dog. A counter included in the control circuitry is incremented in conjunction with each occurrence of an episode of aversive stimulus applied to the dog in response to barking by the dog.

### BACKGROUND OF THE INVENTION

The present invention relates generally to collar-mounted electronic “bark limiter” devices, and more particularly to improvements therein which allow monitoring of the amount of barking that actually occurs.

A variety of electronic dog training collars have been utilized for applying electrical shock and/or audible stimulus to a dog when it barks. In many situations it is highly desirable to prevent individual dogs or groups of dogs from barking excessively. For example, one dog's barking in a kennel is likely to stimulate other dogs to bark. This is undesirable with respect to the welfare of the dogs themselves and nearby people. Similar problems occur in neighborhoods in which there are dogs that are kept outside at night: if one dog starts barking others are likely to join in, causing a general disturbance.

The closest prior art is believed to include the present assignee's Bark Limiter product and commonly assigned U.S Pat. No. 4,947,795 by G. Farkas entitled “Barking Control Device and Method”, issued Aug. 14, 1990 and incorporated herein by reference. Above mentioned U.S. Pat. No. 4,947,795 discloses a bark training device which allows a dog to control the level of electrical stimulus in response to its own barking behavior. This patent discloses circuitry in a collar-mounted electrical device that detects the onset of barking and initially produces only a single low level electrical stimulus pulse that gets the dog's attention, but does not initially produce a highly unpleasant level of stimulation. If the dog continues barking, the stimulation levels of the electrical shock pulses are increased at the onset of each barking episode in a stepwise fashion until the stimulus becomes so unpleasant that the dog stops barking for at least a predetermined time, e.g., one minute. After that minute elapses, the circuitry resets itself to its lowest initial stimultion level and remains inactive until barking begins again, and then repeats the process, beginning with the lowest level of stimulation and increasing the stimulus level if barking continues.

There is an unmet need for an improved bark control device that provides a capability to conveniently determine its own effectiveness by providing a way of conveniently monitoring how often a dog barks over a period of time.

There also is an unmet need for an improved sound vibration sensing device for an animal control device which enables a user to readily determine if the currently set stimulation level is effective.

### SUMMARY OF THE INVENTION

It is an object of the invention to provide an improved bark control device that provides a capability of conveniently determining its own actual effectiveness by providing a way of conveniently monitoring how often a dog barks over a period of time.

It is another object of the invention to provide an improved sound vibration sensing device for an animal control device which enables a user to readily determine if the currently set stimulation level is effective.

Briefly described, and in accordance with one embodiment, the present invention provides a collar-mounted electronic apparatus (1) for control of barking by a dog including a housing (2) supported by a collar for attachment to the dog's neck, first and second stimulus probes (5) connected to a top surface (9) of the housing, a vibration sensor (6) supported by the housing for detecting vibrations caused by barking by the dog and control circuitry in the housing having an input coupled to an output of the vibration sensor, the control circuitry including output terminals producing aversive stimulus signals in response to barking by the dog, wherein a counter included in the control circuitry is incremented in conjunction with each occurrence of an episode of aversive stimulus applied to the dog in response to barking by the dog. The counter is incremented in conjunction with valid barking episodes. In the described embodiment, the control circuitry includes a controller which stores and executes program for determining whether vocalization by the dog constitutes a valid barking episode by electronically converting vocalizing sounds from the dog into a sequence of corresponding signals representing the frequencies of the vocalizing sounds, and providing the sequence of signals as an input to the controller. The controller is operated to determine the frequencies of the sequence of signals during a predetermined interval of time and to determine if each measured frequency lies within any of a plurality of predetermined frequency sub-ranges. If so, then cumulative totals of the frequencies which lie in the sub-ranges, respectively, are incremented in to provide a plurality of cumulative totals that represent a frequency spectrum of the vocalizing sounds. The controller is operated to determine whether the barking sounds constitute a valid bark by operating the controller to compare the frequency spectrum to a predetermined valid bark frequency spectrum, and to cause the control circuitry to cause appropriate aversive stimulus signals to be produced between the first and second stimulus electrodes if the vocalizing sounds constitute a valid bark.

In the described embodiment, the controller executes the program for determining whether vocalization by the dog constitutes a valid barking episode only if a signal is received from a motion sensor indicating that the dog's neck has moved in a characteristic manner caused by barking by the dog. In the described embodiment, the controller stores and executes program for setting an aversive stimulus intensity level in response to manual actuation of a switch of the collar-mounted electronic apparatus, wherein a user can experimentally select an aversive stimulus intensity level that effectively causes the dog to reduce the amount of its barking by determining the amount of barking by monitoring the bark counter. The aversive stimulus intensity level is selected in response to manual actuation of a switch.

### BRIEF DESCRIPTION OF THE DRAWINGS

FIG. 1 is a perspective view of a collar-mounted bark limiter unit of the present invention with the collar removed.

FIG. 2 shows the a partially-exploded view of the bark limiter unit of FIG. 1.

FIG. 3A is a perspective exploded view of the bark limiter unit of FIGS. 1 and 2.

FIG. 3B is a side exploded view of the bark limiter unit as shown in FIG. 3A.

FIG. 4 is a schematic diagram of the circuitry included in the housing of the bark limiter of FIG. 1.

FIGS. 5A, 5B and 5C constitute a flow chart of a program executed by the microcontroller 33 included in FIG. 4.

### DETAILED DESCRIPTION OF THE PREFERRED EMBODIMENTS

The described dog bark limiter of the present invention includes a processor that stores and executes “valid bark detection” software wherein a capture and compare routine in the software is executed to generate a frequency spectrum of the received vocalization of the dog and compare it with a predetermined “valid bark” frequency spectrum to determine if the sound constitutes a “valid” bark. A “bark counter” function is provided that counts the number of barking episodes by counting the number of times the bark limiter applies aversive stimulus to the dog in response to detected “valid” barking episodes.

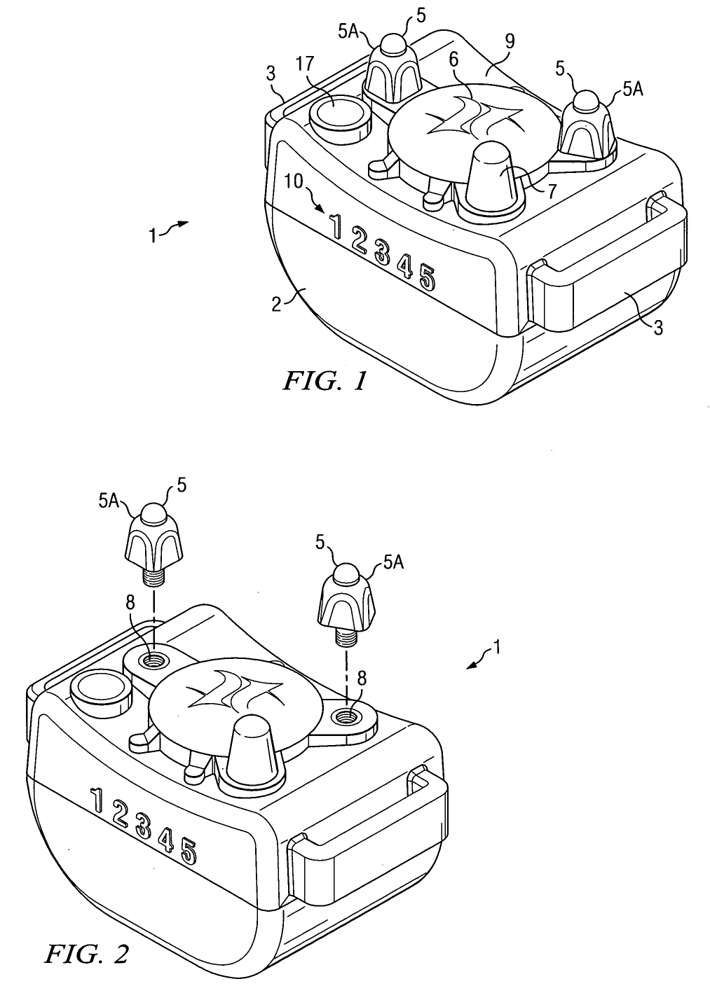

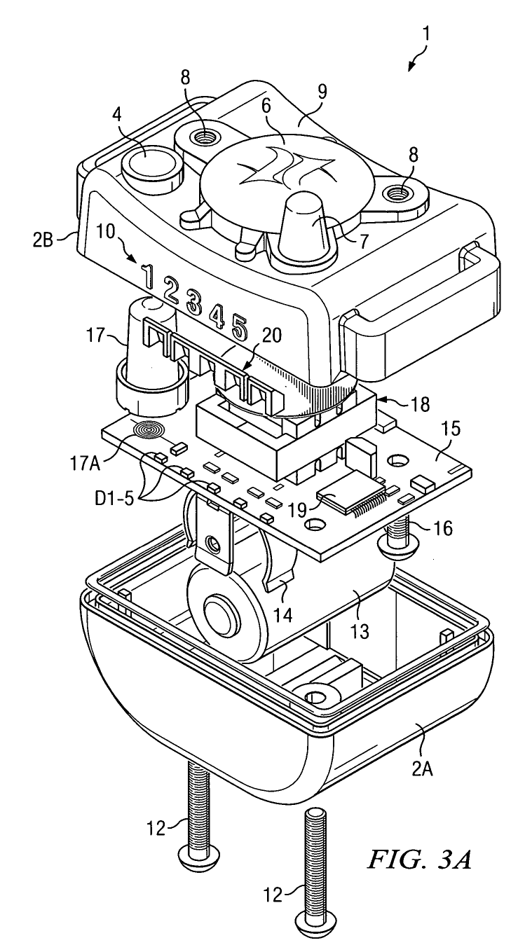

Referring to FIGS. 1, 2, 3A and 3B, bark limiter 1 includes a housing 2 having a lower section 2A and an upper section 2B. The top surface 9 of upper housing section 2B is slightly concave, to better accommodate the curvature of a dog's neck. A pair of collar-retaining loops 3 are attached to opposite ends of upper housing section 2B, as shown. A typical dog collar (not shown) is passed through loops 3 around the bottom surface of housing 2 to fasten bark limiter 1 to the dog's neck. Two stimulus electrodes 5 are threaded into receiving holes 8 (FIG. 2) in the upper surface 9, and their conductive tips are pressed against the dog's neck to make electrical contact therewith when the collar is tightened. As indicated in FIG. 2, stimulus electrodes 5 are removable. In accordance with one aspect of the present invention, a preferably non-conductive stabilizing post of the same height as stimulus probes 5 is rigidly attached to upper surface 9, and is offset from a straight line between stimulus probes 5 to prevent a the conductive electrode tips of stimulus electrodes 5 from “rocking” against the dog's neck to reduce the occurrence and severity of sores on the dog's neck.

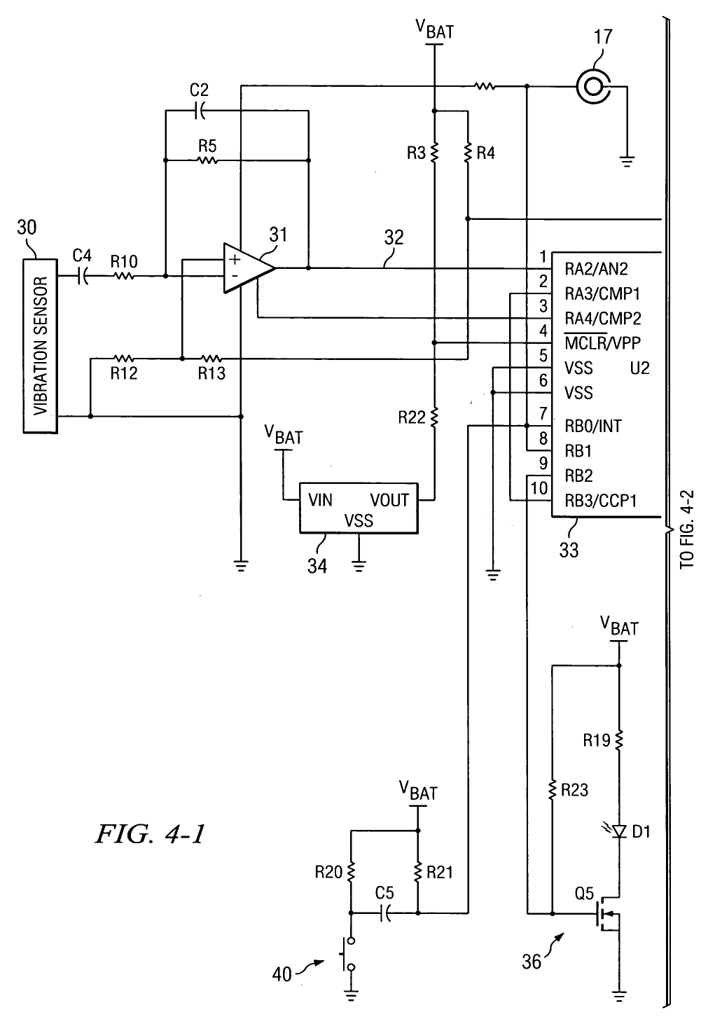

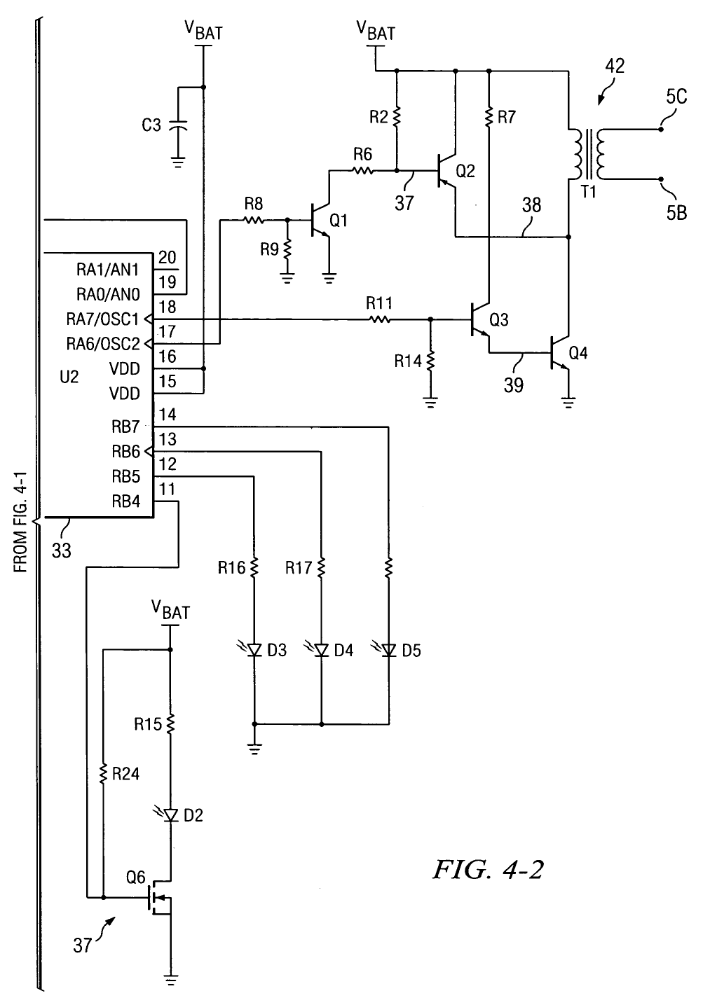

A dome-shaped membrane 6 that preferably is integrally formed with the upper housing section 2B is disposed on upper surface 9 and constitutes part of an improved vibration sensor 30, which is subsequently described in more detail with reference to FIG. 4. A membrane switch 17 extends through an opening 4 in upper surface 9. The dog owner can repetitively depress membrane switch 17 to select one of five stimulus intensity levels. The selected intensity level is indicated by illumination of one of the five indicators identified by reference numeral 10.

Membrane switch 17 also can be depressed for a 4 second interval to set bark limiter 1 to a test mode, subsequently described. The above features, except the stimulus probes 5B and 5C, on the upper surface 9 of upper housing 2B are all integrally formed as a single unit.

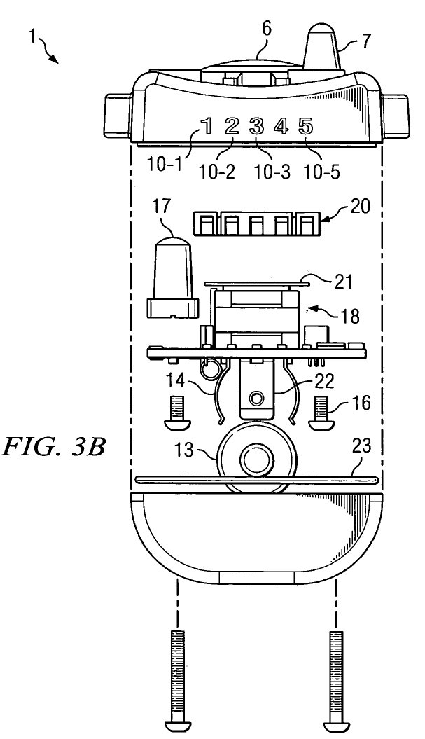

Referring to the exploded views of FIGS. 3A and 3B, lower housing section 2A is attached to upper housing section 2B by means of two screws 12. A printed circuit board 15A contained within housing 2 is attached to upper housing section 2B by means of two screws 16. A 3 volt lithium battery 13 is attached to the bottom of printed circuit board 15A by means of a pair of clips 14. The membrane switch unit 17 is attached to the upper surface of printed circuit board 15A and extends through hole 4 in upper surface 9. A metal trace 17A is contacted to provide a switch closure when the upper surface of membrane switch unit 17 is depressed. An output transformer 18, a microcontroller 19, and five light emitting diodes D1-5 are mounted on the upper surface of printed circuit board 15. As shown in FIG. 3B, a piezoelectric transducer 21 is supported on output transformer 18, and is contacted by a “nipple” formed on the underside of dome-shaped membrane 6.

The intensity indicators 10-1,2,3,4,5 become illuminated by light emitting diodes D1-5, respectively, as membrane switch 17 is successively depressed. The five LEDs correspond to indicators 10-1,2,3,4,5 to indicate which stimulation level has been selected by means of the membrane switch 17. The LED corresponding to the intensity level selected by means of membrane switch 17 is the one which blinks. The arrangement of membrane switch 17 and the LED display arrangement including the lens reflector 20 minimizes the possibility of water leakage into the housing of the bark control device. The RB2, 4, 5, 6, and 7 outputs of microcontroller 33 in FIG. 4 selectively turn on LEDs D1-5, respectively, in response to the pressing of membrane switch 17.

Referring to FIG. 4, the circuitry of bark limiter 1 is provided on the upper surface of printed circuit board 15A (FIG. 3A), and includes vibration sensor assembly 30 which includes above mentioned dome-shaped membrane 6, piezoelectric transducer 21, and the above-mentioned nipple formed on the underside of membrane 6 in order to efficiently transmit vibrations from membrane 6 to piezoelectric transducer 21. One of the electrodes of piezoelectric transducer 21 is connected to ground and the other is coupled by capacitor C4 and resistor R10 to the (−) input of an operational amplifier 31. The (+) input of operational amplifier 31 is connected to the junction between resistor R12 and resistor R13. The other terminal of resistor R12 is connected to ground, and the other terminal of resistor R13 is connected to one terminal of resistor R4 and to the RA0 input on lead 19 of microcontroller 33. The other terminal of resistor R4 is connected to the battery voltage VBAT.

The output of operational amplifier 31 is connected by conductor 32 to the RA2 input on lead 1 of microcontroller 33 and also is connected to one terminal of capacitor C2 and one terminal of resistor R5. The other terminals of resistors R5 and capacitor C2 are connected to the (−) input of operational amplifier 31. The RA2 input of microcontroller 33 is connected to one input of an internal comparator, the other input of which is connected to the RA0 terminal of microcontroller 33, in order to produce an internal square waveform to be used as an input to the internal microprocessor portion of microcontroller 33, to allow the frequency of the square waveform to be determined. The capacitor C2 functions as a low pass filter that sets the upper cutoff frequency of operational amplifier 31. The resistors R5 and R10 to determine the gain of operational amplifier 31.

Voltage monitor circuit 34 in FIG. 4 produces a low output voltage if VBAT is less than approximately 2 volts, and applies a reset signal to the microcontroller reset input MCLR on lead 4 thereof if VBAT is below approximately 2 volts. A resistor R4, in combination with resistors R13 and R12, forms a threshold circuit that establishes a threshold voltage to be applied to the internal comparator of microcontroller 33 via its RA0 input.

The output of the internal comparator of microcontroller 33 is produced on lead 2 of microcontroller 33, which is externally connected to the CCP1 input on lead 2 of microcontroller 33. The CCP1 input of microcontroller 33 is used in the subsequently described compare-capture mode of operation, to measure the periods of the square waveforms on the CCP1 input. This allows the signals produced by vibration transducer 30 and amplified by operational amplifier 31 to be captured within an approximately 120 millisecond interval and, in effect, assembled into a frequency spectrum including sixteen 40 Hz windows in the range from 150 Hz to 800 Hz which can be used to determine if the present sound is a valid bark.

Actuation of the motion sensor 40 in FIG. 4 results in a signal applied to lead 7 of microcontroller 33 to indicate whether the dog's present neck motion is of the kind characteristically caused by barking. Microprocessor 33 automatically switches from low-power standby operation at 37 kHz to normal operation at 4 MHz if this signal indicates that the dog has begun barking.

The RA6 output on lead 17 of microcontroller 33 is coupled to the base of an NPN transistor Q1 having its emitter connected to ground and its collector coupled by a resistor R6 to the base of a PNP transistor Q2 having its collector connected to VBAT and its emitter connected by conductor 38 to one terminal of the primary winding of output transformer 42. The base of transistor Q2 also is coupled by a resistor R2 to VBAT. The RA7 output on lead 18 of microcontroller 33 is coupled to the base of an NPN transistor Q3 which has its collector coupled by resistor R7 to VBAT and its emitter connected to the base of an NPN transistor Q4. The emitter of transistor Q4 is connected to ground and its collector is connected to conductor 38. The other terminal of the primary winding of output transformer 42 is connected to VBAT. The secondary winding terminals 5B and 5C are connected to the two stimulus electrodes 5.

Transistor Q4, when turned on, produces a constant collector current for the entire amount of time that transistor Q4 is turned on. If all of the collector current of transistor Q4 flows through the primary winding of transformer 42, that results in delivery of a maximum amount of energy to the primary winding of transformer 42 and therefore in a maximum amount output energy delivered to the stimulus probes 5 by the secondary winding of transformer 42. However, if transistor Q2 is turned on after the peak Vp of the flyback spike that occurs in the waveform of the voltage on conductor 38 immediately after transistor Q4 is turned off, then some of the decaying current in the primary winding of transformer 42 is shunted, causing the voltage on conductor 38 to rapidly fall to zero. This reduces the amount of energy delivered to the primary winding of transformer 42 for each pulse of the waveform on conductor 39 applied to the base of transistor Q4 by microcontroller 33, and therefore also reduces the amount of stimulus energy delivered through stimulus probes 5 to the dog's neck.

Microcontroller 33 operates to produce a burst of pulses which are applied to the base of transistor Q4 via the Darlington circuit configuration including transistor Q3. The intensity of the stimulation applied to the dog's neck is controlled by synchronously turning on shunt transistor Q2 to divert a controlled amount of the collector current of transistor Q4 away from the primary winding of transformer 42.

Thus, in one embodiment of the invention two control signals are in effect applied by microcontroller 33 to control the energizing of the primary winding of the output transformer, including the constant-width turn-on pulse signal applied to the gate of MOSFET Q4 to establish the constant open circuit voltage produced between the stimulus probes, and also including a shunt control signal which controls the synchronous turn-on of shunt transistor Q2 after the occurrence of the peak value of the flyback voltage on conductor 38 in order to control the amount of energy delivered to the primary winding of the transformer, and therefore the amount of RMS stimulus energy delivered the dog.

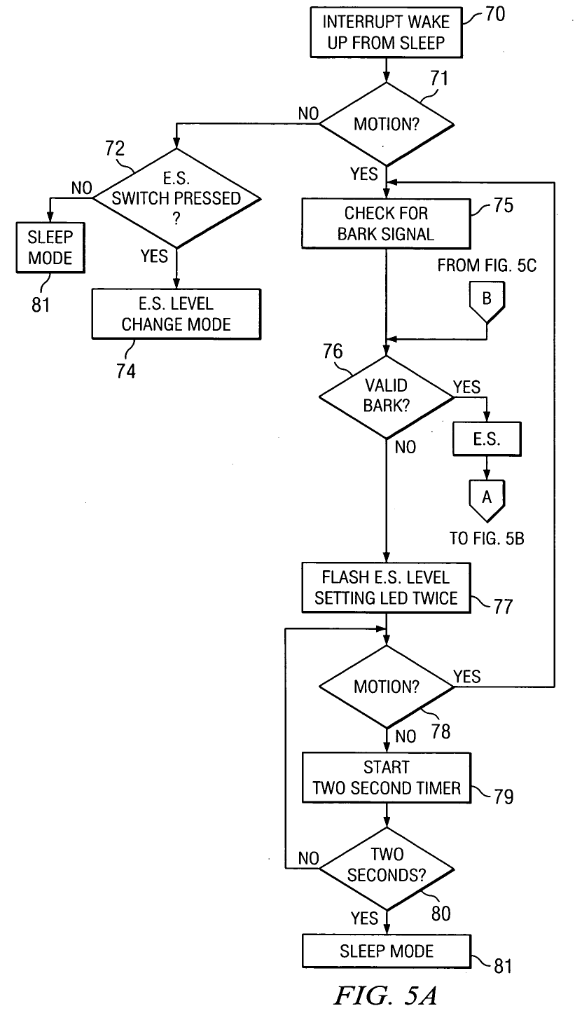

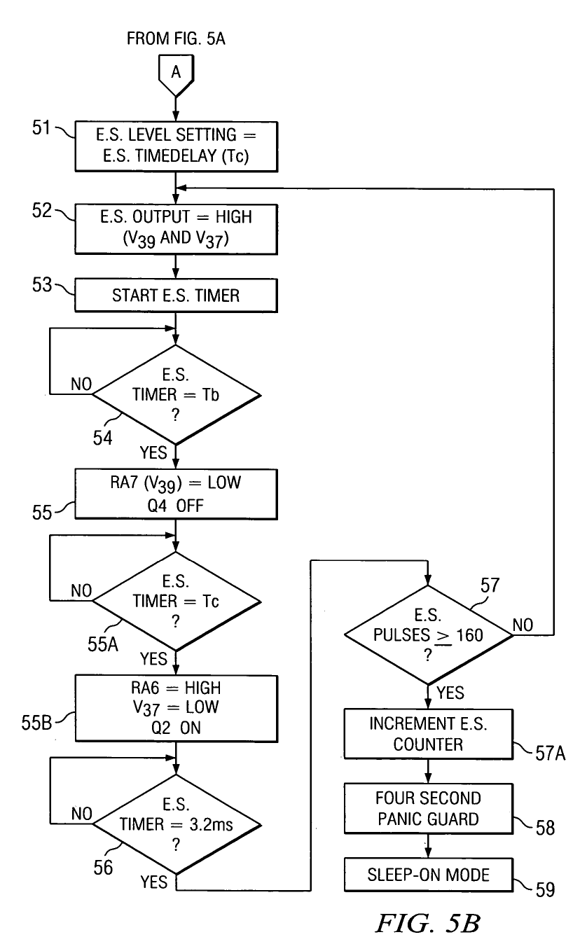

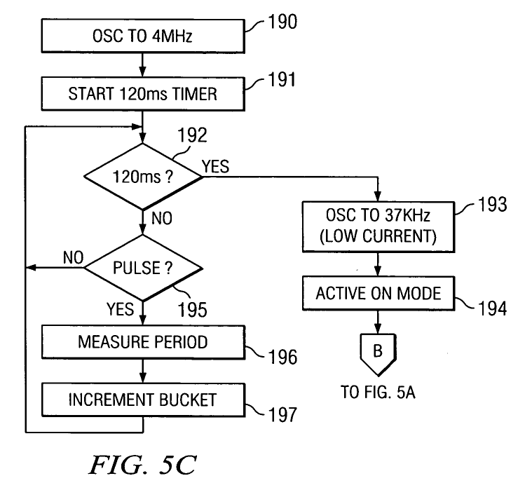

The microcontroller 33 used in the improved bark limiter 1 of the present invention preferably is a PIC16F628 available from Microchip Technology Incorporated, which includes several signal conditioning operational amplifiers, and operates so as to perform the same functions of executing the program represented by the flowchart of FIGS. 5A, 5B, and 5C. Microcontroller 33 includes a flash memory, a random access memory for storing file registers, and a non-volatile EEPROM for storing the operating program and valid bark detection algorithms. Microcontroller 33 also includes the above-mentioned comparator which generates the signal Data In, and also includes a Vref circuit that produces 1 of 16 voltage levels provided as inputs to the comparator input if the comparator input is configured so that a Vref input is needed.

By way of definition, the terms “controller” and “microcontroller” are used herein is intended to encompass any microcontroller, digital signal processor (DSP), logic circuitry, state machine, and/or programmed logic array (PLA) that performs functions of microcontroller 33 as described above.

Motion sensor 40 can be a Model #SQ-SEN-001P Ultra Compact Tilt and Vibration Sensor, available from SignalQuest Inc. Motion sensor 40 is of a mechanical ball-in-tube construction, and includes a conductive ball that makes contact with appropriate electrodes in response to motion of the dog's neck in order to send the “wake-up” signal microcontroller 33. The assignee has discovered that dogs move their heads in a characteristic manner when they bark, and that using motion detector 40 improves accuracy in bark detection of “valid” barking. Specifically, the assignee has discovered that when dogs bark, they tend to move their heads and upper torso in a specific motion/pattern motion that can be detected by the above described motion detector 40, although in some instances other types of motion detectors might be used. Motion patterns that are characteristic of barking can be detected using motion detector 40 and, in accordance with the present invention, a captured digitized bark signal can be utilized to provide a frequency spectrum that represents a “valid” bark in order to provide more accurate bark detection that has previously been achieved.

In accordance with the present invention, the vibration detection operation and motion detection operation are combined to determine whether an aversive stimulus signal should be produced between electrodes 5B and 5C. The motion detection is used primarily as part of detection of a valid bark, and is used secondarily to accomplish awakening bark limiter 1 from its sleep mode. Either the subsequently described “valid bark” detection based on the frequency spectrum of signals received from vibration sensor 30 or motion signals based on movement of motion detector 40 could be considered the primary detection function and the other could be considered to be the secondary detection function. The bark limiter could be awakened or powered up in response to barking, and the aversive stimulus could then be triggered by detection of neck motion, or vice versa.

The ON mode includes both the SLEEP mode and the ES LEVEL CHANGE mode. The OFF mode allows the bark limiter 1 to be awakened as a result of a switch trigger signal produced by depressing switch 17, and if that occurs, the program executed by microprocessor 33 checks to determine if switch 17 is depressed for least 0.1 seconds, and if it is not, automatically goes back into the SLEEP mode. If bark limiter 1 is in both the ON mode and the SLEEP mode, and a signal is received from motion sensor 40, it immediately checks for a bark signal from vibration sensor 30 while microprocessor 33 is internally operating at 4 MHz, and if there is no bark signal from vibration sensor 30, and the internal clock signal is reduced to 37 kHz, waits for a period of 2 seconds, and then reenters the SLEEP mode. Thus, a user can determine if bark limiter 1 is in its ON mode by subjecting bark limiter 1 to sufficient motion to cause motion sensor 40 to produce a motion signal and noticing if the light emitting diodes blink several times.

With the foregoing information in mind, it can be seen that the present invention provides an improved technique of “valid bark” detection with software by using the internal “Capture/Compare module” of the PIC16LF627 microcontroller 33 to determine “valid” barks, and uses a bark counter to count the number of valid barking episodes. During a 120 ms (or similar) capture time interval, the periods of the various bark signal frequencies are measured and counted. A window of acceptable frequencies in the range of, for example, 150 Hz-800 Hz, is created by the software. This interval or “window” is divided into 16 “buckets” or “bucket counters” into which the counts of 16 evenly divided frequency ranges are stored. When a bark/sound signal is received, the periods of the bark frequencies are measured during the 120 ms capture interval. The period of the frequency component of the received bark/sound signal is measured, and if the measured period falls within one of the 16 buckets, i.e. frequency ranges, then a software counter assigned to that bucket is incremented. For each complete bark signal/sound captured, the bucket counter totals are compared to predetermined threshold levels for each corresponding bucket counter, respectively in order to determine whether the dog's vocalization (or other detected sound) constitutes a “valid” bark.

A software “bark counter” is executed by microcontroller 33 to count the number of times the dog is subjected to an aversive stimulus episode in response to detection of a “valid barking episode” while bark limiter 1 is mounted on the dog. The contents of the bark counter is determined by the trainer or dog owner when the collar is removed and turned off. This allows the trainer or owner to determine if a particular one of a group of dogs of dogs is a “problem barker”, and also allows the trainer or owner to recognize how effectively the bark limiter 1 is training a particular dog. For example, numerous valid barks being counted early in the use of bark limiter 1, followed by fewer valid barks as the dog is training progresses, indicates effective operation of bark limiter 1. The valid bark count also can provide information that is useful to the user in selecting the most effective setting of electrical stimulus intensity.

FIG. 5A shows how bark limiter 1 is awakened from its “SLEEP” mode in response to a motion-indicating interrupt signal from motion detector 40. If a motion signal is received by microcontroller 33, the program goes from decision block 71 to block 75 and checks to determine if any signal is being received on conductor 32 in response to vibration sensor 30. In decision block 76, the program executes the subroutine of FIG. 5C to determine if the spectrum of sound signals received from vibration sensor 30 is the spectrum of a “valid bark”. If this determination is affirmative, the program goes to the routine of FIG. 5B to generate an aversive electrical stimulus signal between stimulation electrodes 5B and 5C.

Referring to FIG. 5B, in block 51 the program executed by microcontroller 33 determines the selected stimulation level, i.e., determines the electrical stimulus time delay value that results in a waveform that has been set by means of switch 17 and stores it in the non-volatile memory of microcontroller 33. As indicated in block 52, microcontroller 33 sets the voltages on conductors 37 and 39 to high levels in block 52 in order to switch on the primary winding current in transformer 42, and then in block 53 starts a software timer “ES (electro-stimulus) Timer” to the value “E.S. Time Delay” determined in block 51. The program then goes to decision block 54 and continues to “loop” as long as the count of “ES Timer” of block 53 has a value less than “E.S. Time Delay”. After the selected time delay interval has elapsed, the program goes to block 55B and sets the signal RA7 on lead 18 of microcontroller 33 to a low level, which causes the voltage on conductor 39 to go to a low level and causes the flyback transition of the waveform on conductor 38 to occur. After a delay Tc has elapsed, as indicated in decision block 55A, the program sets the level RA7 on lead 18 of microcontroller 33 to a high-level, V37 to a low level, and turns transistor Q2 on. Every stimulation pulse produced by microcontroller 33 on the base of transistor Q3 has a duration of 3.2 milliseconds. For every stimulus signal produced by microcontroller 33, block 56 of the program of FIG. 5B causes the stimulus output signal produced by microcontroller 33 on its lead 2 to be at a low level until the 3.2 milliseconds has elapsed.

The program then goes to decision block 57 and determines if the number of stimulus pulses produced by microcontroller 33 is less than or equal to 160 (which corresponds to approximately half a second of electrical stimulation applied between probes 5B and 5C), and if that determination is affirmative, the program goes back to the entry point of block 52 and continues to repeat the foregoing sequence until a negative decision is made in block 57. The program then increments the software bark counter, as indicated in block 57A, and then goes to block 58 and then, as indicated in block 58, starts a 4 second panic guard routine to prevent “panic barking” that can be caused by the electrical stimulus experienced by the dog, and then the program causes microcontroller 33 to go into its sleep mode, as indicated in block 59.

Referring again to FIG. 5A, if the decision of block 76 is that no valid bark is occurring, the program goes to block 77 and causes the LED corresponding to the selected stimulation level to flash twice, and then goes to decision block 78 and determines if a signal from motion detector 40 indicates that a significant neck motion is occurring. If this determination is affirmative, the program returns to the entry point of block 75 to determine if a bark signal is being received from vibration sensor 30. If the determination of block 78 is negative, the program goes to blocks 79 and 80 and determines if a 2 second interval elapses without neck motion being detected, and if this happens, the program causes microcontroller 33 to go into its sleep mode, as indicated in block 81.

If the determination of decision block 71 is negative, the program goes to decision block 72 and determines if switch 17 is depressed. If switch 17 is not depressed, the program causes microcontroller 33 to go into its sleep mode. If decision block 72 determines that switch 17 is depressed, the program responds in block 74 by determining and storing the new desired stimulus level established by repetitive depressing of switch 17. Specifically, in block 74 the program determines if switch 17 is depressed for more than 1 second, and if this is the case, increments the stimulation level setting from the present level setting (1-5) to the next level setting and saves the new stimulus level setting.

The routine performed in decision block 76 of FIG. 5A is shown in FIG. 5C. Referring to FIG. 5C, in block 190 the program switches the internal oscillator clock frequency of microcontroller 33 from 37 kHz to 4 MHz and then goes to block 191 and starts a 120 millisecond timer, to create a 120 millisecond window within which a “valid bark”, if present, is to be “captured”. The program then goes to decision block 192 and tests the output of the 120 millisecond timer, and after the 120 millisecond window elapses, the program goes to block 192A and runs a subroutine to determine if the vocalization detected is a valid bark. This is accomplished by comparing the number of times the frequency of the detected vocalization is captured in each frequency range or “bucket” within the 120 millisecond window with a predetermined number of times for each bucket.

The program then goes to block 193 and switches the internal oscillator clock frequency of microcontroller 33 back to 37 kHz to provide low power ON mode operation. The program then returns to the entry point of decision block 76 of FIG. 5A. If block 192 determines that the 120 milliseconds timer is still counting, the program then goes to decision block 195 and determines if there is a change in the level of the signal on leads 2 and 10 of microcontroller 33 to indicate that a “pulse” is present. If this determination is negative, the program reenters the entry point of decision block 192, but if the presence of the pulse is detected, the program goes to block 196 and measures the duration of the pulse, and in block 197 increments the frequency spectrum “bucket” or counter which corresponds to the period (i.e., frequency) measured in block 196. The program then reenters decision block 192 and continues the process until the 120 millisecond timer elapses. The “pulse” referred to is generated on lead 2 of microcontroller 33 from an internal comparator therein and is provided as an input to lead 10 of microcontroller 33, which is the “capture and compare∞ (CCP1) input of microcontroller 33, and automatically starts a timer at the beginning of the pulse and stops the timer at the end of the pulse, so the frequency of the signal coming from vibration sensor 30 is thereby determined and can be used to select the appropriate frequency spectrum bucket to be incremented in order to acquire the frequency spectrum of the present bark signals received from vibration sensor 30 by one input of the internal comparator referred to. Lead 2 of microcontroller 33 is the output of that comparator. The reference applied to the other input of the internal comparator is established by the voltage on lead 19 by the resistive voltage divider circuitry shown in FIG. 4.

While the invention has been described with reference to several particular embodiments thereof, those skilled in the art will be able to make the various modifications to the described embodiments of the invention without departing from its true spirit and scope. It is intended that all elements or steps which are insubstantially different from those recited in the claims but perform substantially the same functions, respectively, in substantially the same way to achieve the same result as what is claimed are within the scope of the invention.

1. A collar-mounted electronic apparatus for control of barking by a dog, comprising:
(a) a housing supported by a collar for attachment to the dog's neck;
(b) first and second stimulus probes connected to a top surface of the housing;
(c) a vibration sensor supported by the housing for detecting vibrations caused by barking by the dog;
(d) control circuitry in the housing having an input coupled to an output of the vibration sensor, the control circuitry including output terminals producing aversive stimulus signals in response to barking by the dog;
(e) a counter included in the control circuitry incremented in conjunction with each occurrence of an episode of aversive stimulus applied to the dog in response to barking by the dog.

2. The collar-mounted electronic apparatus of claim 1 wherein the counter is incremented in conjunction with valid barking episodes, and wherein the control circuitry includes a controller which stores and executes program for determining whether vocalization by the dog constitutes a valid barking episode by
(1) electronically converting vocalizing sounds from the dog into a sequence of corresponding signals representing the frequencies of the vocalizing sounds, and providing the sequence of signals as an input to the controller;
(2) operating the controller to determine the frequencies of the sequence of signals during a predetermined interval of time;
(3) operating the controller to determine if each measured frequency lies within any of a plurality of predetermined frequency sub-ranges and if so, then incrementing cumulative totals of the frequencies which lie in the sub-ranges, respectively, to provide a plurality of cumulative totals that represent a frequency spectrum of the vocalizing sounds;
(4) determining whether the barking sounds constitute a valid bark by operating the controller to compare the frequency spectrum to a predetermined valid bark frequency spectrum; and
(5) operating the microcontroller to cause the control circuitry to cause appropriate aversive stimulus signals to be produced between the first and second stimulus electrodes if the determination of step (d) determines that the vocalizing sounds constituted a valid bark.

3. The collar-mounted electronic apparatus of claim 2 wherein the controller executes the program for determining whether vocalization by the dog constitutes a valid barking episode only if a signal is received from a motion sensor indicating that the dog's neck has moved in a characteristic manner caused by barking by the dog.

4. The collar-mounted electronic apparatus of claim 1 wherein the control circuitry includes a controller which stores and executes program for setting an aversive stimulus intensity level in response to manual actuation of a switch of the collar-mounted electronic apparatus, wherein a user can experimentally select an aversive stimulus intensity level that effectively causes the dog to reduce the amount of its barking by determining the amount of barking by monitoring the bark counter.

5. The collar-mounted electronic apparatus of claim 4 including means for selecting the aversive stimulus intensity level in response to manual actuation of a switch.

6. A method of determining the amount of barking by a dog, comprising:
(a) providing a collar-mounted electronic apparatus for control of barking by a dog including a housing supported by a collar for attachment to the dog's neck, stimulus probes connected to a surface of the housing, a vibration sensor supported by the housing for detecting vibrations caused by barking by the dog, and control circuitry in the housing having an input coupled to an output of the vibration sensor, the control circuitry including output terminals producing aversive stimulus signals in response to barking by the dog; and
(b) incrementing a counter included in the control circuitry in conjunction with each occurrence of an episode of aversive stimulus applied to the dog in response to barking by the dog.

7. The method of claim 6 including
(1) determining whether vocalization by the dog constitutes a valid barking episode by
i. electronically converting vocalizing sounds from the dog into a sequence of corresponding signals representing the frequencies of the vocalizing sounds, and providing the sequence of signals as an input to the controller,
ii. operating a controller in the control circuitry to determine the frequencies of the sequence of signals during a predetermined interval of time,
iii. operating the controller to determine if each measured frequency lies within any of a plurality of predetermined frequency sub-ranges and if so, then incrementing cumulative totals of the frequencies which lie in the sub-ranges, respectively, to provide a plurality of cumulative totals that represent a frequency spectrum of the vocalizing sounds,
iv. determining whether the barking sounds constitute a valid bark by operating the controller to compare the frequency spectrum to a predetermined valid bark frequency spectrum;
(2) operating the microcontroller to cause the control circuitry to cause appropriate aversive stimulus signals to be produced between the stimulus electrodes if the vocalizing sounds constituted a valid bark; and
(3) incrementing the counter in conjunction with valid barking.

8. The method of claim 7 including determining whether vocalization by the dog constitutes a valid barking episode only if a signal is received by the controller from a motion sensor indicating that the dog's neck has moved in a characteristic manner caused by barking by the dog.

9. The method of claim 7 wherein the control circuitry includes a controller which stores and executes program for setting an aversive stimulus intensity level in response to manual actuation of a switch of the collar-mounted electronic apparatus, the method including experimentally selecting an aversive stimulus intensity level that effectively causes the dog to reduce the amount of its barking by determining the amount of barking on the basis of observing the contents of the bark counter.

10. A method of determining the determining the effectiveness of the aversive stimulus intensity level of a bark limiter device including a housing supported by a collar for attachment to the dog's neck, stimulus probes connected to a surface of the housing, a vibration sensor supported by the housing for detecting vibrations caused by barking by the dog, and control circuitry in the housing having an input coupled to an output of the vibration sensor, the control circuitry including output terminals producing aversive stimulus signals in response to barking by the dog, the method including
(a) incrementing a counter included in the control circuitry in conjunction with each occurrence of an episode of aversive stimulus applied to the dog in response to barking by the dog;
(b) determining the contents of the counter after an interval of time has elapsed; and
(c) manually increasing the aversive stimulus intensity level of the bark limiter device if the contents of the counter after the interval of time indicates excessive barking by the dog during the interval of time.

11. A system for determining the amount of barking by a dog, comprising:
(a) a collar-mounted electronic apparatus for control of barking by a dog including a housing supported by a collar for attachment to the dog's neck, stimulus probes connected to a surface of the housing, a vibration sensor supported by the housing for detecting vibrations caused by barking by the dog, and control circuitry in the housing having an input coupled to an output of the vibration sensor, the control circuitry including output terminals producing aversive stimulus signals in response to barking by the dog; and
(b) means for incrementing a counter included in the control circuitry in conjunction with each occurrence of an episode of aversive stimulus applied to the dog in response to barking by the dog.

12. The system of claim 11 including
(1) means for determining whether vocalization by the dog constitutes a valid barking including
i. means for electronically converting vocalizing sounds from the dog into a sequence of corresponding signals representing the frequencies of the vocalizing sounds, and means for providing the sequence of signals as an input to the controller,
ii. means for operating a controller in the control circuitry to determine the frequencies of the sequence of signals during a predetermined interval of time,
iii. means for operating the controller to determine if each measured frequency lies within any of a plurality of predetermined frequency sub-ranges and if so, then incrementing cumulative totals of the frequencies which lie in the sub-ranges, respectively, to provide a plurality of cumulative totals that represent a frequency spectrum of the vocalizing sounds,
iv. means for operating the controller to compare the frequency spectrum to a predetermined valid bark frequency spectrum to determine whether the barking sounds constitute a valid bark by;
(2) means for operating the microcontroller to cause the control circuitry to cause appropriate aversive stimulus signals to be produced between the stimulus electrodes if the vocalizing sounds constituted a valid bark; and
(3) means for incrementing the counter in conjunction with valid barking.

13. The system of claim 11 including means for determining whether vocalization by the dog constitutes a valid barking episode only if a signal is received by the controller from a motion sensor indicating that the dog's neck has moved in a characteristic manner caused by barking by the dog.

14. The system of claim 11 wherein the control circuitry includes a controller which stores and executes program for setting an aversive stimulus intensity level in response to manual actuation of a switch of the collar-mounted electronic apparatus, and means for experimentally selecting an aversive stimulus intensity level that effectively causes the dog to reduce the amount of its barking by determining the amount of barking on the basis of observing the contents of the bark counter.
